(19) United States
(12) Patent Application Publication
(10) Pub. No.: US 2017/0098021 A1
(43) Pub. Date: Apr. 6, 2017

(54) METHOD OF ESTIMATING THE PARAMETERS AND STATE OF POWER SYSTEM OF ELECTRIC VEHICLE

(71) Applicant: BEIJING INSTITUTE OF TECHNOLOGY, BEIJING (CN)

(72) Inventors: HONGWEN HE, BEIJING (CN); RUI XIONG, BEIJING (CN); YONGZHI ZHANG, BEIJING (CN); JIANKUN PENG, BEIJING (CN)

(73) Assignee: BEIJING INSTITUTE OF TECHNOLOGY

(21) Appl. No.: 15/355,049

(22) Filed: Nov. 17, 2016

Related U.S. Application Data
(63) Continuation of application No. PCT/CN2014/078608, filed on May 28, 2014.

(30) Foreign Application Priority Data
May 26, 2014 (CN) 201410225424.8

(51) Int. Cl. G06F 17/50; G06F 17/16; B60L 3/00; G06F 17/11

(52) U.S. Cl. CPC G06F 17/5009; G06F 17/11; G06F 17/16; B60L 3/0023; B60L 3/0061; B60L 3/0046

(57) ABSTRACT

A method for estimating parameters and the state of a power system of an electric vehicle is disclosed. A multi-time scale model of the power system is set up; a parameter observer AEKF_{θ} based on a macroscopic time scale and a state observer AEKF, based on a microcosmic time scale in the power system of the electric vehicle are initialized; time update is performed on the parameter observer AEKF_{θ}, the updating time span is one macroscopic time scale, and a priori estimation value \hat{θ}⁻ₗ at the moment t_{1,0}, of the parameter θ is obtained; time update and measurement update are performed on the state observer AEKFₓ and circulated for L times, so that the time of the state observer AEKFₓ is updated to the moment t_{0,1}; and measurement update is performed on the parameter observer AEKF_{θ}, and the operation is circulated until the estimation is finished. By means of the method, the parameters and the state of the power system of the electric vehicle are estimated, the precision is high, the calculation time is short, and calculation costs are reduced.

### CROSS-REFERENCE TO RELATED APPLICATIONS

This application is a continuation of International Patent Application No. PCT/CN20141078608 with a filing date of May 28, 2014. designating the United States, now pending, and further claims priority to Chinese Patent Application No. 201410225424.6 with a filing date of May 26, 2014. The content of the aforementioned applications, including any intervening amendments thereto, are incorporated herein by reference.

### TECHNICAL FIELD

This invention is about system identification and state estimation, especially related to methods of parameter and state estimation of a power system made up of a drive motor and a battery used in electric vehicles, as well as an electric vehicle battery management system.

### BACKGROUND OF THE PRESENT INVENTION

State-space is a general method to deal with the nonlinear control system. When using the state-space to the nonlinear control system, the state equation is applied to describe the dynamical characteristics of the nonlinear control system, and the observation equation is used to describe the relationship of observations and states of nonlinear control system. Based on which, the hidden states will be estimated in real time by using the observed information involved noise. However, the uncertain parameters contained in the state equation and observation equation have negative influence and will result in the low estimation accuracy of the hidden states of nonlinear control systems.

In order to solve this problem and improve the hidden states estimation accuracy of the nonlinear control system, the technicians in this field often identify the uncertain parameters of state equation and observation equation by an experimental way. Then the hidden states of nonlinear control system will be estimated based on the determined state-space equation.

For example, the technicians in the battery control field often obtain the battery parameter by an experimental approach to construct the battery model. Then, the battery state estimation and optimization of the electric vehicle energy management will be operated based on the constructed battery model. Because the battery parameter set is influenced by the internal and external factors, such as battery aging and environmental change, which will lead to obvious change of the battery parameter sets, stable and reliable state estimation will be hard to obtain based on the previously constructed battery models. Furthermore, it is hard to obtain the convergent and optimal solution by using the traditional Kalman filter approach, since the battery parameter possesses the slow time-varying characteristics caused by the internal and external factors while the battery state possesses the fast time-varying characteristics influenced by the parameter change, which will result in the increase of calculation burden of the control system.

In conclusion, because the parameter of the nonlinear control system will change, it is hard to obtain the stable and reliable state estimate when applying the parameter identified by the experimental approach to estimate the nonlinear control system state. Besides, as a result of the slow time-varying characteristics of the system parameter set and fast time-varying characteristics of the system state, the long calculation time and high calculation burden will be caused by using the traditional Kalman filter for the state estimation of the nonlinear control system.

Also, the estimation error is within 5% with the commonly used battery management system applied in electric vehicles for SoC estimation, and the available capacity estimation error is within 10%,

### SUMMARY OF PRESENT INVENTION

In order to get stable and reliable state estimation of the electric vehicle and reduce the calculation cost, this invention proposes a method for estimating the parameters and the state of a power system of an electric vehicle. The method comprises the following steps of:

Step 1, constructing a multi-time scale model of he power system

$$\{ \begin{matrix}{x}_{k , l + 1} = F ( {x}_{k , l} , {θ}_{k} , {u}_{k , l} ) + {ω}_{k , l} , {θ}_{k + 1} = {θ}_{k} + {ρ}_{k} \\ {Y}_{k , l} = G ( {x}_{k , l} , {θ}_{k} , {u}_{k , l} ) + {v}_{k , l}\end{matrix} ,$$

in which

θ indicates the parameters of the power system,

x indicates a hidden state of the power system,

F (x_{k,l}, θₖ, u_{k,l}) indicates a state function of the multi-time scale model,

G(x_{k,l}, θₖ, u_{k,l}) indicates an observation function of he multi-tune scale model,

x_{k,l} is the power system state at moment t_{k,l}=t_{k,0}+l×Δt(1≦l≦L), and k is the macroscopic time scale, l is the microscopic time scale, L is the transfer threshold between the microscopic and macroscopic time scale.

u_{k,l} is the input information of the power system at a moment t_{k,l},

Y_{k,l} is the measurement matrix of the power system at a moment t_{k,l},

ω_{k,l} is the white noise of the power system state, its mean is zero and its covariance is Q_{k,l}^{x},

ρ_{k,l} is the white noise of the power system parameter, its mean is zero and its covariance is Qₖ^{θ},

ν_{k,l} is the measurement white noise of the power system, its mean is zero and its covariance is R_{k,l},

θₖ=θ_{0L-l},

Step 2, initializing θ₀, P₀^{θ}, Q₀^{θ} and R₀ of the parameter observer AEKF₀ based on the macroscopic time scale, in which

θ₀ is the parameter initial value of the parameter observer AEKF_{θ},

P_{θ}^{θ} is the initial covariance error matrix value the parameter estimation of the parameter observer AEKF_{θ},

Q₀^{θ} is the initial covariance error matrix value of the power system noise of the parameter observer AEKF_{θ},

R₀ is the observation noise of the pare meter observer AEKF_{θ};

initializing x_{θ,θ}, P_{θ,θ}^{x}, Q_{θ,θ}^{x} and R_{θ,θ} of the state observer AEKF, based on the microscopic time scale, in which,

x_{θ,θ} is the initial state value of the power system of the state observer AEKFₓ,

P_{θ,θ}^{x} is the initial covariance error matrix value of the state estimation of the state observer AEKFₓ,

Q_{θ,θ}^{x} is the initial covariance error matrix value of the power system noise of the state observer AEKF_{θ},

R_{θ,θ} is the initial covariance matrix of the observation noise of the state observer AEKFₓ;

and Rₖ=R_{k,0,L-1};

Step 3, performing time update on the parameter observer AEKF_{θ}, in which the updated time scale is a macroscopic time scale, and getting the prior estimate \hat{θ}⁻ₗ of θ at the moment t_{1,0}, and

$$\{ \begin{matrix}{\hat{θ}}_{1}^{-} = {\hat{θ}}_{0} \\ {P}_{1}^{0 , -} = {P}_{0}^{0} + {Q}_{0}^{0}\end{matrix} ;$$

Step 4, performing time update and measurement update on the state observer AEKFₓ;

performing time update on the state observer AEKFₓ, in which the updated time scale is a microscopic time scale, and obtaining the prior estimate \hat{x}⁻_{0.3} of x at the moment t_{0.3}, wherein

$$\{ \begin{matrix}{\hat{x}}_{0 , 1}^{-} = F ( {\hat{x}}_{0 , 0}^{-} , {\hat{θ}}_{0}^{-} , {u}_{0 , 1} ) \\ {P}_{0 , 1}^{x , -} = {A}_{0 , 1} {P}_{0 , 1}^{x} {A}_{0 , 1}^{T} + {Q}_{0 , 1}^{x}\end{matrix} ,$$

A_{0.3} is the Jacobian matrix of the state function of power system at the moment t_{0.3} applied in electric vehicles, and

$${A}_{0 , 1} = \frac{\partial F ( x , {\hat{θ}}_{0}^{-} , {u}_{0 , 1} )}{\partial x} {\vert}_{x = {\hat{x}}_{0 , 1}} ,$$

and

T is the matrix transpose;

updating the state observer AEKFₓ based on the measurement, and obtaining the posterior estimate \hat{x}⁻_{0.1} of x;

updating the innovation matrix for state estimation to get:

e_{0.1}=Y_{0.1}−G(\hat{x}⁻_{0.1}, \hat{θ}⁻ₗ,u_{0.3}),

wherein the Kalman gain matrix is:

K_{0.1}^{x}=P_{0.1}^{x,-}(C_{0.3}^{x})^{T}(C_{0.3}^{x}P_{0.1}^{T}(C_{0.1}^{x})^{T}=R_{θ, θ})⁻¹,

the window length function of voltage error estimation is

$${H}_{0 , 1}^{x} = \frac{1}{{M}_{x}} {\sum }_{i = 1 - {M}_{x} + 1}^{l} {e}_{0 , 1} {e}_{0 , 1}^{T} ;$$

updating the covariance matrix of noise:

$$\{ \begin{matrix}{R}_{0 , 1} = {H}_{0 , 1}^{x} - {C}_{0 , 1}^{x} {{P}_{0 , 1}^{x , -} ( {C}_{0 , 1}^{x} )}^{T} \\ {Q}_{0 , 1}^{x} = {K}_{0 , 1}^{x} {{H}_{0 , 1}^{x} ( {K}_{0 , 1}^{x} )}^{T}\end{matrix} ;$$

correcting the state estimate: \hat{x}⁻_{0.1}=\hat{x}⁻_{0.1}=K_{0.1}^{x}[Y_{0.1}−G(\hat{x}⁻_{0.1}, \hat{θ}⁻₁u_{0.3})];

updating the estimate error covariance of state:

P_{0.1}^{T}=(I−K_{0.1}^{x}C_{0.1}^{x})P_{0.3}^{x,-};

where

C_{0.3}^{x} is the Jacobian matrix of the observation function of power system at the moment t_{0.1} applied in electric vehicles, and

$${C}_{0 , 1}^{x} = \frac{\partial G ( x , {\hat{θ}}_{1}^{-} , {u}_{0 , 1} )}{\partial x} {\vert}_{x = {\hat{x}}_{0 , 1}} ;$$

cycling the above operations for L times until the moment of state observer AEKFₓ is updated to t_{0.1}, then going to the next step;

Step 5, updating the parameter observer AEKF_{θ} based on the measurement to get the posterior estimate \hat{θ}⁻₁;

updating the innovation matrix for parameter estimation to get:

e₁^{θ}=Y_{1.0}−G(\hat{x}⁻_{1.0},\hat{θ}⁻₁,u_{1.0}), wherein

the Kalman gain matrix is: K₁^{θ}=P₁^{θ}−(C₁^{θ})^{T}(C₁^{θ}P₁^{θ,-}(C₁^{θ})^{T}+R₀)⁻¹, and

the window length function of voltage error estimation is:

$${H}_{1}^{θ} = \frac{1}{{M}_{θ}} {\sum }_{i = 1 - {M}_{o} + 1}^{l} {{e}_{1}^{θ} ( {e}_{1}^{θ} )}^{T} ;$$

updating the covariance matrix of noise:

$$\{ \begin{matrix}{R}_{1} = {H}_{1}^{θ} - {C}_{1}^{θ} {{P}_{1}^{θ , -} ( {C}_{1}^{θ} )}^{T} \\ {Q}_{1}^{θ} = {K}_{t}^{θ} {{H}_{1}^{θ} ( {K}_{1}^{θ} )}^{T}\end{matrix} ;$$

correcting the state estimate: \hat{θ}⁻₁=\hat{θ}⁻ₗ+K₁^{θ}e₁^{θ};

updating the estimate error covariance of state:

Pₗ^{θ,-}=(I−K₁^{θ}C₁^{θ})P₁^{θ,-},

where

C₁^{θ} is the Jacobian matrix of the observation function of power system at the moment t_{1,0} applied in electric vehicles, and

$${C}_{1}^{0} = \frac{\partial G ( {\hat{x}}_{1 , 0} , θ , {u}_{1 , 0} )}{\partial θ} {\vert}_{θ = {\hat{x}}_{1}^{-}} ;$$

cycling the operations of step 3 and step 4 until the moment t_{k,l};

performing time update on the parameter observer AEKF_{θ} to get the prior estimate \hat{θ}⁻ₖ of parameter θ at the moment t_{k,l}, wherein

$$\{ \begin{matrix}{\hat{θ}}_{k}^{-} = {\hat{θ}}_{k - 1} \\ {P}_{k}^{θ , -} = {P}_{k - 1}^{θ} + {Q}_{k - 1}^{θ}\end{matrix} ;$$

performing time update on the state observer AEKFₓ to get the prior estimate \hat{x}⁻_{k-1,l} of state \hat{x}⁻_{k-1,l} at the moment t_{k,l}, wherein

$$\{ \begin{matrix}{\hat{x}}_{k - 1 , l}^{-} = F ( {\hat{x}}_{k - 1 , l - 1}^{-} , {\hat{θ}}_{k}^{-} , {u}_{k - 1 , l - 1} ) \\ {P}_{k - 1 , l}^{x , -} = {A}_{k - 1 , l - 1} {P}_{k - 1 , l - 1}^{x} {A}_{k - 1 , l - 1}^{T} + {Q}_{k - 1 , l - 1}^{x}\end{matrix} ,$$

A_{0,1} is the Jacobian matrix of the state function of power system at the moment t_{k,l} applied in electric vehicles, and

$${A}_{k - 1 , l - 1} = \frac{\partial F ( x , {\hat{θ}}_{k}^{-} , {u}_{k - 1 , l} )}{\partial x} {\vert}_{x = {\hat{x}}_{k - 1 , l - 1}} ;$$

updating the state observer AEKFₓ based on the measurement to obtain the posterior estimate \hat{x}⁻_{k-1J} of state x at the moment t_{k,l}; updating the innovation matrix for state estimation to get: e_{k-1,l}=Y_{k-1,l}G(\hat{x}⁻_{k-1,l}\hat{θ}⁻ₖu_{k-1,l}), wherein the Kalman gain matrix is:

K_{k-1J}^{x}=P_{k-1,l}^{x,-}(C_{k-1,l}^{x})^{T}(C_{k-1J}^{x}P_{k-1,l}^{x,-}(C_{k-1,l}^{x})^{T}+R_{k-1/-1})⁻¹;

matching the covariance adaptively:

$${H}_{k - 1 , l}^{x} = \frac{1}{{M}_{x}} {\sum }_{i = l - {M}_{x} + 1}^{l} {e}_{k - 1 , l} {e}_{k - 1 , l}^{T} ;$$

updating the noise covariance:

$$\{ \begin{matrix}{R}_{k - 1 , l} = {H}_{k - 1 , l}^{x} - {C}_{k - 1 , l}^{x} {{P}_{k - 1 , l}^{x , -} ( {C}_{k - 1 , l}^{x} )}^{T} \\ {Q}_{k - 1 , l}^{x} = {K}_{k - 1 , l}^{x} {{H}_{k - 1 , l}^{x} ( {K}_{k - 1 , l}^{x} )}^{T}\end{matrix} ;$$

correcting the state estimate:

\hat{x}⁻_{k-1,l} =\hat{x}⁻_{k-1,l}+K_{k-1,l}^{x}[Y_{k-1,l}−G(\hat{x}⁻_{k-1,l},\hat{θ}⁻ₖ,u_{k-1,l})];

updating the error covariance of state estimate:

P_{k-1,l}^{x,+}=(I−K_{k-1,l}^{x}C_{k-1,l}^{x})P_{k-1,l}^{x,-},

where

C_{k-1,l}^{x} is the Jacobian matrix of the observation function of power system at the moment t_{k,l} applied in electric vehicles, and

$${C}_{k - 1 , l}^{x} = \frac{\partial G ( x , {\hat{θ}}_{k}^{-} , {u}_{k - 1 , l} )}{\partial x} {\vert}_{x = {\hat{x}}_{k - 1}}$$

updating the parameter observer AEKF_{θ} based on the measurement to obtain the posterior estimate \hat{θ}⁻ₖ of parameter θ at the moment t_{k,0:l,};

updating the innovation matrix for parameter estimation to get:

eₖ^{θ}=Y_{k,θ}−G(\hat{x}⁻_{k,θ},\hat{θ}⁻ₖ,u_{k,θ}), wherein

the Kalman gain matrix is:

K_{k-1,l}^{x}=P_{k-1,l}^{x,-}(C_{k-1,l}^{x})^{T}(C_{k-1,l}^{x}P_{k-1,l}^{x,-}(C_{k-1,l}^{x})^{T}+R_{k-1,l-l})⁻¹;

matching the covariance adaptively:

$${H}_{k}^{θ} = \frac{1}{{M}_{θ}} {\sum }_{i = 1 - {M}_{θ} + 1}^{l} {{e}_{k}^{0} ( {e}_{k}^{θ} )}^{T} ;$$

updating the noise covariance:

$$\{ \begin{matrix}{R}_{k} = {H}_{k}^{θ} - {C}_{k}^{θ} {{P}_{k}^{θ , -} ( {C}_{k}^{θ} )}^{T} \\ {Q}_{k}^{θ} = {K}_{k}^{θ} {{H}_{k}^{θ} ( {K}_{k}^{θ} )}^{T}\end{matrix} ;$$

correcting the state estimate: \hat{θ}⁻ₖ=\hat{θ}⁻ₖ+Kₖ^{θ}eₖ^{θ};

updating the error covariance of state estimate:

Pₖ^{θ,+}=(I−Kₖ^{θ}Cₖ^{θ})Pₖ^{θ,-},

where

Cₖ^{θ} is the Jacobian matrix of the observation function of power system at the moment t_{k,0:l,} applied in electric vehicles, and

$${C}_{k}^{0} = \frac{\partial G ( {\hat{x}}_{k , 0} , θ , {u}_{k , 0} )}{\partial θ} {\vert}_{θ = {\hat{x}}_{k}^{-}} ;$$

and

cycling the above operations until the estimation is completed,

the state observer AEKFₓ, in which the updated time scale is a, and obtain the prior estimate \hat{x}⁻_{θ,l} of x at the moment t_{θ,l}, and

$$\{ \begin{matrix}{\hat{x}}_{0 , 1}^{-} = F ( {\hat{x}}_{0 , 0}^{-} , {\hat{θ}}_{0}^{-} , {u}_{0 , 1} ) \\ {P}_{0 , 1}^{x , -} = {A}_{0 , 1} {P}_{0 , 1}^{x} {A}_{0 , 1}^{T} + {Q}_{0 , 1}^{x}\end{matrix} ,$$

the parameter observer AEKF_{θ} to get the prior estimate \hat{θ}⁻ₖ of parameter θ at the moment t_{k,l}, and

$$\{ \begin{matrix}{\hat{θ}}_{k}^{-} = {\hat{θ}}_{k - 1} \\ {P}_{k}^{θ , -} = {P}_{k - 1}^{θ} + {Q}_{k - 1}^{θ}\end{matrix} ;$$

the state observer AEKFₓ to get the prior estimate \hat{x}⁻_{k-1,l} of state \hat{x}⁻_{k-1,l} at the moment t_{k,l}, and

$$\{ \begin{matrix}{\hat{x}}_{k - 1 , l}^{-} = F ( {\hat{x}}_{k - 1 , l - 1}^{-} , {\hat{θ}}_{k}^{-} , {u}_{k - 1 , l - 1} ) \\ {P}_{k - 1 , l}^{x , -} = {A}_{k - 1 , l - 1} {P}_{k - 1 , l - 1}^{x} {A}_{k - 1 , l - 1}^{T} + {Q}_{k - 1 , l - 1}^{x}\end{matrix} ,$$

When using this invention to estimate the power system parameter and state of electric vehicles, in the same moment, the innovation source is the same for the macroscopic time scale and microscopic time scale, which will be beneficial to improve the parameter and state estimates convergence and the estimate accuracy. The calculation time and cost will both be reduced by estimating the power system parameter and state of electric vehicles based on the multi-scale.

Preferably, when performing time update on the state observer AEKFₓ, the cycle length of microscopic time scale is l=1:L, and when the macroscopic time scale transfers to k from k-1, the microscopic time scale will changes to 0 from L.

Preferably, the driving cycles data of the power system applied in electric vehicles is input to the state estimation filter in real-time. In this case, the state estimation filter can estimate the parameter and state based on the driving data closest to the real working conditions of power system applied in electric vehicles, which can improve the estimation accuracy.

Also, this invention proposes a battery management system which can use any of the above power system state and parameter estimation methods applied in electric vehicles to estimate the battery parameter and state of electric vehicles. Compared with the present mainstream battery management system, the proposed battery management system has higher accuracy, lower time-consuming and is more safe and reliable.

### DESCRIPTION OF THE DRAWINGS

FIG. 1 is the schematic diagram of he proposed multi-time scale adaptive extended Kalman filter algorithm;

FIG. 2 is the equivalent circuit diagram by equalizing the battery of an electric vehicle to the equivalent circuit model with a first order RC network;

FIG. 3 is the cycle data of a power battery applied in electric vehicles; FIG. 3(a) is the current changing curve of cell cycling; FIG. 3(b) is the state of changing SoC curve of cell cycling.

FIG. 4 is the open circuit voltage curve by equalizing the battery of electric vehicle to the equivalent circuit model with a first order RC network;

FIG. 5 is the joint estimation results of battery parameter and state applied in electric vehicles based on the multi-time scale, and the time scale transfer threshold is L=60 s with the battery initial SoC value being 60%. FIG. 5(a) is the battery voltage estimation error curve; FIG. 5(b) is the battery SoC estimation curve; FIG. 5(c) is the available capacity estimation curve; FIG. 5(d) is the battery available capacity estimation error curve;

FIG. 6 is the joint estimation results of battery parameter and state applied in electric vehicles based on the same time scale, and the time scale transfer threshold is L=1 s with the battery initial SoC value being 60%. In which, FIG. 6(a) is the battery voltage estimation error curve; FIG. 6(b) is the battery SoC estimation curve; FIG. 6(c) is the available capacity estimation curve; FIG. 6(d) is the battery available capacity estimation error curve;

FIG. 7 is the equivalent circuit diagram by equalizing the battery of electric vehicle to the equivalent circuit model with second order RC networks;

FIG. 8 is the joint estimation results of battery parameter and state applied in electric vehicles based on the multi-time scale, and the time scale transfer threshold is L=60 s with the battery initial SoC value being 60%. In which, FIG. 8(a) is the battery voltage estimation error curve; FIG. 8(b) is the battery SoC estimation curve; FIG. 8(c) is the available capacity estimation curve; FIG. 8(d) is the battery available capacity estimation error curve.

### DETAILED DESCRIPTION OF PREFERRED EMBODIMENTS

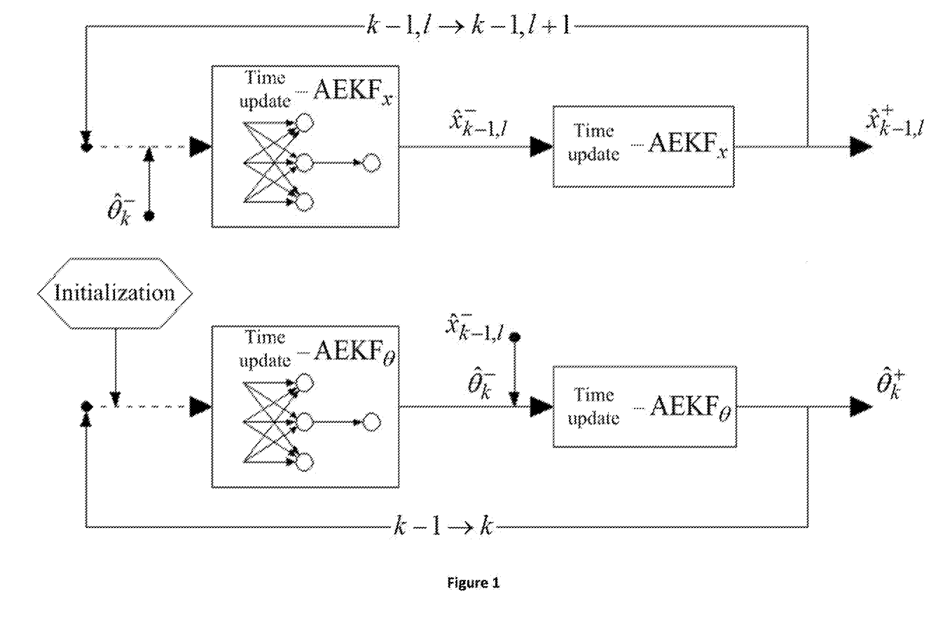

The specific operation steps of this invention to estimate the power system parameter and state of electric vehicles are illustrated in details based on FIG. 1.

Step 1, build the multi-time scale power system model of electric vehicles, which is shown as (1),

$$\{ \begin{matrix}{x}_{k , l + 1} = F ( {x}_{x , l} , {θ}_{k} , {u}_{k , l} ) + {ω}_{k , l} , {θ}_{k + 1} = {θ}_{k} + {ρ}_{k} \\ {Y}_{k , l} = G ( {x}_{k , l} , {θ}_{k} , {u}_{k , l} ) + {v}_{k , l}\end{matrix} \qquad ( 1 )$$

where,

θ indicates the power system parameter of electric vehicles, and when the macroscopic time scale does not change and the microscopic time scale changes to L-1 from 0, the parameter stays the same which is θₖ=θ_{k,0:L-1}; k is the macroscopic time scale, and L is the scale transfer threshold to transfer the macroscopic time scale to the microscopic time scale, which is t_{k,0}=t_{k-l,0}+L×Δt where Δt is a microscopic time scale;

x is a hidden state of the power system of electric vehicles;

F(x_{k,l},θₖ,u_{k,l}) is the power system state function of electric vehicles at the moment t_{k,l};

G(x_{k,l},θₖ,u_{k,l}) is the power system observation function of electric vehicles at the moment t_{k,l};

x_{k,l} is the power system state of electric vehicles at the moment t_{k,l}, where l is the microscopic time scale and 1≦l≦L,

t_{k,l}=t_{k,0}+l×Δt(1≦l≦L);

u_{k,l} is the input information (control matrix) to the state estimate filter by the power system of electric vehicles, where the input information includes power system current, battery voltage and SoC:

Y_{k,l} is the observation matrix (measurement matrix) of the power system of electric vehicles, where the observation matrix includes the battery voltage, SoC and available capacity of the power system applied in electric vehicles;

ω_{k,l} is the state white noise of the power system of electric vehicles at the moment t_{k,l}, and its covariance matrix is Q_{k,l}^{x},

ρₖ is the parameter white noise of the power system of electric vehicles at the moment t_{k,l}, and its covariance matrix is Qₖ^{θ},

ν_{k,l} is the measurement white noise of the power system of electric vehicles at the moment t_{k,l}, and its covariance is R_{k,l}.

Step 2, initialize the parameter observer AEKF_{θ} based on the macroscopic time scale and the state observer AEKFₓ based on the microscopic time scale of the power system applied in electric vehicles.

Specifically, initialize the parameter θₖ, Pₖ^{θ}, Qₖ^{θ} and Rₖ of the parameter observer AEKF_{θ} to obtain θ₀, P_{θ}^{θ}, Q_{θ}^{θ} and R_{θ}, where,

θ₀ is the initial parameter value of the power system of electric vehicles,

P₀^{θ}is the initial value of error covariance matrix Pₖ^{θ} of the power system parameter estimate applied in electric vehicles,

Q₀^{θ} is the initial value of error covariance matrix Qₖ^{θ} of the power system noise applied in electric vehicles,

R₀ is the initial value of observation noise covariance Rₖ of the parameter observer AEKF₀.

Initialize the parameter x_{k,l}, P_{k,l}^{x}, Q_{k,l}^{x} and R_{k,l} of the state observer AEKFₓ to obtain x_{θ,θ}, P_{θ,θ}^{x}, Q_{θ,θ}^{x} and R_{θ,θ}, where,

x_{θ,θ} is the initial value of power system state x_{k,l} of electric vehicles,

P_{θ,θ}^{x} is the initial value of state estimation error covariance P_{k,l}^{x} of the power system applied in electric vehicles,

Q_{θ,θ}^{x} is the initial value of system noise covariance Q_{k,l}^{x} the power system of electric vehicles,

R_{θ,θ} is the initial value of system noise covariance R_{k,l} the state observer AEKFₓ,

As the parameter observer AEKF_{θ} and state observer AEKFₓ has the relationship as Rₖ=R_{k,0.L-1}, herein R_{θ}=R_{θ,θ}.

Step 3, perform time update on the parameter observer AEKF_{θ} based on the macroscopic time scale which is prior parameter estimation with a macroscopic time scale to obtain the prior estimate \hat{θ}⁻ₗ of θ at the moment t_{1,θ}, wherein

$$\{ \begin{matrix}{\hat{θ}}_{1}^{-} = {\hat{θ}}_{0} \\ {P}_{1}^{θ , -} = {P}_{0}^{θ} + {Q}_{0}^{θ}\end{matrix} . \qquad ( 2 )$$

Step 4, perform time update and measurement update of the state observer AEKFₓ.

Firstly, perform time update on the state observer AEKF_{θ} based on the microscopic time scale which is prior parameter estimation with a microscopic time scale Δt to obtain the prior estimate \hat{x}⁻_{θ,l} of x at the moment t_{θ,1}, wherein

$$\{ \begin{matrix}{\hat{x}}_{0 , 1}^{-} = F ( {\hat{x}}_{0 , 0}^{-} , {\hat{θ}}_{0}^{-} , {u}_{0 , 1} ) \\ {P}_{0 , 1}^{x , -} = {A}_{0 , 1} {P}_{0 , 1}^{x} {A}_{0 , 1}^{T} + {Q}_{0 , 1}^{x}\end{matrix} , \qquad ( 3 )$$

A_{θ,1} is the Jacobian matrix of state function of the power system applied in electric vehicles in the estimation process,

$${A}_{0 , 1} = \frac{\partial F ( x , {\hat{θ}}_{0}^{-} , {u}_{0 , 1} )}{\partial x} {\vert}_{x = {\hat{x}}_{0 , 1}} , \qquad ( 4 )$$

and

T represents the matrix transpose.

Then, update the state observer AEKFₓ based on the microscopic time scale to obtain the posterior estimate \hat{x}⁻_{θ,l}.

Update the innovation matrix of state estimation to get:

e_{θ,l[=Y}_{θ,1}−G(\hat{x}⁻_{θ,1},\hat{θ}⁻ₗ,u_{θ,1}) (5),

wherein

the Kalman gain matrix is:

K_{θ,l}^{x}=P_{θ,l}^{x,-}(C_{θ,3}^{x})^{x}(C_{θ,3}^{x}P^{x,-}_{θ,l}(C_{θ,l}^{x})^{x}+R_{θ,θ})⁻¹ (6) and

the window length function of voltage estimation error (which is also called adaptive covariance matching) is:

$${H}_{0 , 1}^{x} = \frac{1}{{M}_{x}} {\sum }_{i = 1 - {M}_{x} + 1}^{l} {e}_{0 , 1} {e}_{0 , 1}^{T} . \qquad ( 7 )$$

Update the noise covariance to get:

$$\{ \begin{matrix}{R}_{0 , 1} = {H}_{0 , 1}^{x} - {C}_{0 , 1}^{x} {{P}_{0 , 1}^{x , -} ( {C}_{0 , 1}^{x} )}^{T} \\ {Q}_{0 , 1}^{x} = {K}_{0 , 1}^{x} {{H}_{0 , 1}^{x} ( {K}_{0 , 1}^{x} )}^{T}\end{matrix} . \qquad ( 8 )$$

Correct the state estimate to get:

\hat{x}⁻_{θ,l}=\hat{x}⁻_{θ,1}+K^{x}_{θ,l}[Y_{θ,l}−G(\hat{x}⁻_{θ,l}, \hat{θ}⁻ₗ,u_{θ,l})] (9)

Update the error covariance of state estimation:

P^{x,-}_{θ,l}=(I−K^{x}_{θ,l}C^{x}_{θ,l})P^{x,-}_{θ,l} (10),

where

C^{x}_{θ,l} is the Jacobian matrix of the observation function at the moment t_{θ,l} of the power system applied in the electric vehicles in the state estimation process, and

$${C}_{0 , 1}^{x} = \frac{\partial G ( x , {\hat{θ}}_{1}^{-} , {u}_{0 , 1} )}{\partial x} {\vert}_{x = {\hat{x}}_{0 , 1}} . \qquad ( 11 )$$

Cycle the above operation for L times to update the state observer AEKFₓ based on the microscopic time scale to moment t_{θ,l} which is t_{1,θ}, then turn to the next step.

Step 5, update the state observer AEKF_{θ} based on the macroscopic time scale to obtain the posterior estimate \hat{θ}⁻ₗ of parameter θ at the moment t_{1,0}.

Update the innovation matrix of parameter estimation to get:

e^{θ}ₗ=Y_{1,0}−G(\hat{x}⁻_{1,0},\hat{θ}⁻ₗ,u_{1,0}) (12).

The Kalman gain matrix is:

K^{θ}ₗ=P^{θ,-}ₗ(C^{θ}ₗ)^{x}(C^{θ}ₗP^{θ,-}ₗ(C^{θ}ₗ)^{x}+R_{θ})⁻¹ (13)

The window length function of voltage estimation error which is adaptive covariance matching is:

$${H}_{1}^{θ} = \frac{1}{{M}_{0}} {\sum }_{i = 1 - {M}_{o} + 1}^{l} {{e}_{1}^{θ} ( {e}_{1}^{θ} )}^{T} . \qquad ( 14 )$$

Update the noise covariance to get:

$$\{ \begin{matrix}{R}_{1} = {H}_{1}^{θ} - {C}_{1}^{θ} {{P}_{1}^{θ , -} ( {C}_{1}^{θ} )}^{T} \\ {Q}_{1}^{θ} = {K}_{1}^{θ} {{H}_{1}^{θ} ( {K}_{1}^{θ} )}^{T}\end{matrix} . \qquad ( 15 )$$

Correct the state estimate to get:

\hat{θ}⁻ₗ=θ₁+K^{θ}ₗe^{θ}ₗ (16).

Update the error covariance of state estimation:

P^{θ,-}ₗ=(I−K^{θ}ₗC^{θ}ₗ)P^{θ,-}ₗ (17)

where,

C^{θ}ₗ is the Jacobian matrix of the observation function at the moment t_{1,0} of the power system applied in the electric vehicles in the state estimation process, in which C^{θ}ₗ is the partial differential equation about state of the observation function of the power system applied in electric vehicles, so

$${C}_{1}^{θ} = \frac{\partial G ( {\hat{x}}_{1 , 0} , θ , {u}_{1 , 0} )}{\partial θ} {\vert}_{θ = {\hat{x}}_{1}^{-}} . \qquad ( 18 )$$

Cycle the operation of step 3 and step 4 until the moment t_{k,l}.

Perform time update on the parameter observer AEKF_{θ} based on the macroscopic time scale to get the prior estimate \hat{θ}⁻ₖ of parameter θ at the moment t_{k,l}, wherein

$$\{ \begin{matrix}{\hat{θ}}_{k}^{-} = {\hat{θ}}_{k - 1} \\ {P}_{k}^{θ , -} = {P}_{k - 1}^{θ} + {Q}_{k - 1}^{θ}\end{matrix} . \qquad ( 19 )$$

Perform time update on the state observer AEKF_{θ} based on the microscopic time scale to get the prior estimate \hat{x}⁻_{k-1,l} of state x at the moment t_{k,l}, wherein

$$\{ \begin{matrix}{\hat{x}}_{k - 1 , l}^{-} = F ( {\hat{x}}_{k - 1 , l - 1}^{-} , {\hat{θ}}_{k}^{-} , {u}_{k - 1 , l - 1} ) \\ {P}_{k - 1 , l}^{x , -} = {A}_{k - 1 , l - 1} {P}_{k - 1 , l - 1}^{x} {A}_{k - 1 , l - 1}^{T} + {Q}_{k - 1 , l - 1}^{x}\end{matrix} , \qquad ( 20 )$$

A_{k-1,l-1} the Jacobian matrix of the state function at the moment t_{k,l} of the power system applied in the electric vehicles in the state estimation process, and

$${A}_{k - 1 , l - 1} = \frac{\partial F ( x , {\hat{θ}}_{k}^{, -} , {u}_{k - 1 , l} )}{\partial x} \vert x = {\hat{x}}_{k - 1 , l - 1} . \qquad ( 21 )$$

Update the state observer AEKFₓ according to the measurement based on the microscopic time scare to get the posterior estimate \hat{x}⁻_{k-1,l} of state x at the moment t_{k,l}.

Update the innovation matrix of state estimation to get:

e_{k-1,l}=Y_{k-1,l-}G(\hat{x}⁻_{k-1,l},\hat{θ}⁻ₖ,u_{k-1,l}) (22).

The Kalman gain matrix is:

K^{x}_{k-1,l}=P^{x,-}_{k-1,l}(C^{x}_{k-1,l})^{T}(C^{x,-}_{k-1,l}P^{x,-}_{k-1,l}(C^{x}_{k-1,l})^{T}+R_{k-1,l-1})⁻¹ (23).

Match the covariance adaptively to get:

$${H}_{k - 1 , l}^{x} = \frac{1}{{M}_{x}} {\sum }_{i = l - {M}_{x} + 1}^{l} {e}_{k - 1 , l} {e}_{k - 1 , l}^{T} . \qquad ( 24 )$$

Update the noise covariance to get:

$$\{ \begin{matrix}{R}_{k - 1 , l} = {H}_{k - 1 , l}^{x} - {C}_{k - 1 , l}^{x} {{P}_{k - 1 , l}^{x , -} ( {C}_{k - 1 , l}^{x} )}^{T} \\ {Q}_{k - 1 , l}^{x} = {K}_{k - 1 , l}^{x} {{H}_{k - 1 , l}^{x} ( {K}_{k - 1 , l}^{x} )}^{T}\end{matrix} . \qquad ( 25 )$$

Correct the state estimate to get:

\hat{x}⁻_{k-1,l}=\hat{x}⁻_{k-1,l}+K^{x}_{k-1,l}[Y_{k-1,l}−G(\hat{x}⁻_{k-1,l}, \hat{θ}⁻ₖ,u_{k-1,l})] (26).

Because \hat{x}_{k,0}=\hat{x}_{k-1,L}, so

$$\begin{matrix}\frac{d {\hat{x}}_{k , 0}}{d {\hat{θ}}_{k}^{-}} = \frac{d {\hat{x}}_{k - 1 , L}^{+}}{d {\hat{θ}}_{k}^{-}} = \frac{d}{d {\hat{θ}}_{k}^{-}} ( {\hat{x}}_{k - 1 , L}^{-} + {K}_{k - 1 , L - 1}^{x} ( {Y}_{k - 1 , L - 1} - G ( {\hat{x}}_{k - 1 , L}^{-} , {\hat{θ}}_{k ,}^{-} {u}_{k - , L - 1} ) ) ) , & ( 27 ) \\ \frac{d}{d {\hat{θ}}_{k}^{-}} ( {K}_{k - 1 , L - 1}^{x} {Y}_{k - 1 , L - 1} ) = {Y}_{k - 1 , L - 1} \frac{\partial {K}_{k - 1 , L - 1}^{x}}{\partial {\hat{θ}}_{k}^{-}} , \\ and \\ & ( 28 ) \\ \frac{d}{d {\hat{θ}}_{k}^{-}} ( {K}_{k - 1 , L - 1}^{x} G ( {\hat{x}}_{k - 1 , L - 1}^{-} , {\hat{θ}}_{k}^{-} , {u}_{k - 1 , L - 1} ) ) = {K}_{k - 1 , L - 1}^{x} \frac{d G ( {\hat{x}}_{k - 1 , L - 1}^{-} , {\hat{θ}}_{k}^{-} , {u}_{k - 1 , L - 1} )}{d {\hat{θ}}_{k}^{-}} + \frac{\partial {K}_{k - 1 , L - 1}^{x}}{\partial {\hat{θ}}_{k}^{-}} G ( {\hat{x}}_{k - 1 , L - 1}^{-} , {\hat{θ}}_{k}^{-} , {u}_{k - 1 , L - 1} ) . & ( 29 )\end{matrix}$$

Update the error covariance of state estimation to get:

P^{x,-}_{k-1,l}=(I−K^{x}_{k-1,l}C^{x}_{k-1,l})P^{x,-}_{k-1,l} (30),

where,

C^{x}_{k-1,l} is the Jacobian matrix of the observation function at the moment t_{k,l} of the power system applied in the electric vehicles in the state estimation process, and

$${C}_{k - 1 , l}^{x} = \frac{\partial G ( x , {\hat{θ}}_{k}^{-} , {u}_{k - 1 , l} )}{\partial x} \vert x = {\hat{x}}_{k - 1 , l} \qquad ( 31 )$$

Update the parameter observer AEKF_{θ} according to the measurement based on the macroscopic time scale to get the posterior estimate \hat{θ}⁻ₖ of parameter θ at the moment t_{k,θ1}.

Update the innovation matrix of parameter estimation to get:

e^{θ}ₖ=Y_{k,θ}−G(\hat{x}⁻_{k,θ},\hat{θ}⁻ₖ,u_{k,θ}) (32).

The Kalman gain matrix is

K^{θ}ₖ=P^{θ,-}ₖ(C^{θ}ₖ)^{T}(C^{θ}ₖP^{θ,-}ₖ(C^{θ}ₖ)^{x}+Rₖ₋₁)⁻¹ (33).

Match the covariance adaptively to get:

$${H}_{k}^{θ} = \frac{1}{{M}_{θ}} {\sum }_{i = 1 - {M}_{θ} + 1}^{l} {{e}_{k}^{θ} ( {e}_{k}^{θ} )}^{T} . \qquad ( 34 )$$

Update the noise covariance to get:

$$\{ \begin{matrix}{R}_{k} = {H}_{k}^{θ} - {C}_{k}^{θ} {{P}_{k}^{θ , -} ( {C}_{k}^{θ} )}^{T} \\ {Q}_{k}^{θ} = {{K}_{k}^{θ} ( {K}_{k}^{θ} )}^{T}\end{matrix} . \qquad ( 35 )$$

Correct the state estimate to get:

\hat{θ}⁻ₖ=\hat{θ}⁻ₖ+K^{θ}ₖe^{θ}ₖ (36).

Update the error covariance of state estimation to get:

P^{θ,-}ₖ=(I−K⁻ₖC^{θ}ₖ)P^{θ,-}ₖ (37),

where,

C^{θ}ₖ is the Jacobian matrix of the observation function at the moment t_{k,θ,l} of the power system applied in the electric vehicles in the state estimation process, and

$${C}_{k}^{θ} = \frac{\partial G ( {\hat{x}}_{k , 0 ,} θ , {u}_{k , 0} )}{\partial θ} {\vert}_{θ = {\hat{x}}_{k}^{-}} . \qquad ( 38 )$$

Cycle the above operation until the estimation is completed.

In the calculation process, after the parameter and state estimate at the moment k is finished, the time of the state estimation filter will increase to (k)=(k+1)⁻ from (k)⁺, and get ready for the state estimation at moment (k+1), when x_{k,θ}=x⁻_{k,θ}, \hat{θ}ₖ=\hat{θ}⁻ₖ.

When applying the described estimation method to estimate the parameter and state of the power system applied in electric vehicles, the driving cycles data of the power system applied in electric vehicles is input to the state estimation filter in real-time to make the state estimation filter estimate the parameter and state based on the driving data closest to the real working conditions of power system applied in electric vehicles to improve the estimation accuracy. Obviously, the real-time performance of battery parameter is very meaningful to ensure the reliability and accuracy of he battery state estimate.

Besides, in the estimation process, at the same moment, the innovation based on the macroscopic time scale and microscopic time scale comes from the same voltage observation error of the power system applied in electric vehicles. In this case, the convergence of parameter estimate and state estimate, as well as the estimation accuracy, can be improved.

### Embodiment 1

In the following, an example of estimating the battery parameter and state applied in electric vehicles will be provided to illustrate the advantage of applying this invention to obtain the parameters and state of the power system of the electric vehicle.

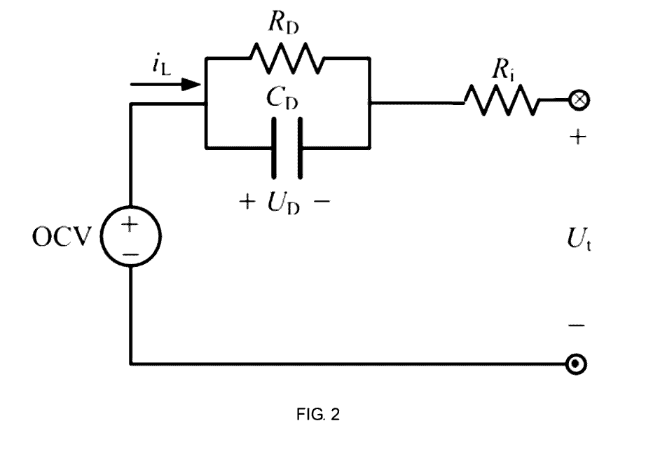

The battery applied in electric vehicles is equalized to the equivalent circuit model with a first order RC network, which is shown as FIG. 2, and the state function and observation function are built as (39),

$$\{ \begin{matrix}{x}_{k , l + 1} = F ( {x}_{k , l} , {θ}_{k} , {u}_{k , l} ) + {ω}_{k , l} \\ {Y}_{k , l} = G ( {x}_{k , l} , {θ}_{k} , {u}_{k , l} ) + {v}_{k , l}\end{matrix} , \qquad ( 39 )$$

### So,

$$\{ \begin{matrix}\begin{matrix}{x}_{k , l + 1} = [ \begin{matrix}exp ( - \frac{{T}_{t}}{{R}_{D} {C}_{D}} ) & 0 \\ 0 & 1\end{matrix} ] {x}_{k , l} + \\ [ \begin{matrix}( 1 - exp ( - \frac{1}{{R}_{D} {C}_{D}} ) ) {R}_{D} \\ - \frac{{T}_{t}}{{C}_{a}}\end{matrix} ] {u}_{k , l + 1} + {ω}_{k , l + 1}\end{matrix} \\ {Y}_{k , l} = g ( x ( 2 ) , {C}_{a} ) - x ( 1 ) - {R}_{l} {u}_{k , l} + {v}_{k , l}\end{matrix} , \qquad ( 40 )$$

where,

Tₜ is the sampling time,

Rₚ is the battery polarization resistance,

C_{D} is the battery polarization capacitance,

Rᵢ is the battery ohmic resistance,

Cₐ is the battery available capacity,

g(x(2),Cₐ) is the battery open circuit model:

The battery parameter to estimate is θ=[R_{D}C_{D}RᵢCₐ], where

x is the battery state to estimate, and the state x includes x(1)−U_{D} and x(2)−SoC. U_{D} the battery polarization voltage.

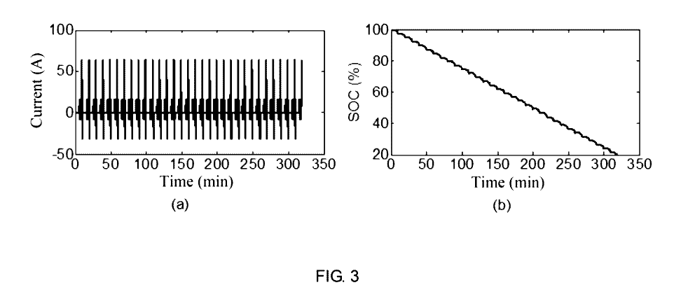

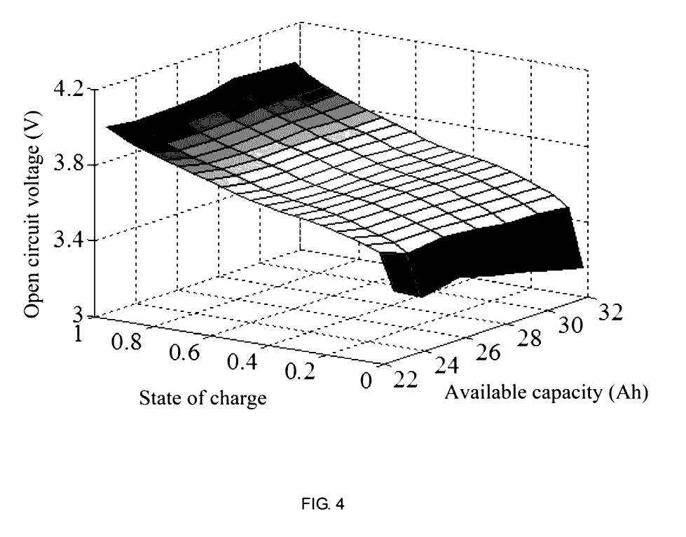

The sampling time Tₗ is set as 1 s (second). The battery current data of driving cycles by the battery experiment is shown in FIG. 3(a). It can be seen that the battery current fluctuates strongly in the driving cycles and the maximum value is up to 70 A (Ampere). FIG. 3(b) shows the battery cell SoC curve in cycles. In which, the battery SoC decreases continually in the driving cycles and the slight fluctuation has been observed with the falling process. The battery open circuit voltage curve is shown in FIG. 4. It can be seen that the battery SoC decreases as the open circuit voltage falls, and the available capacity is 31.8 Ah (Ampere hour).

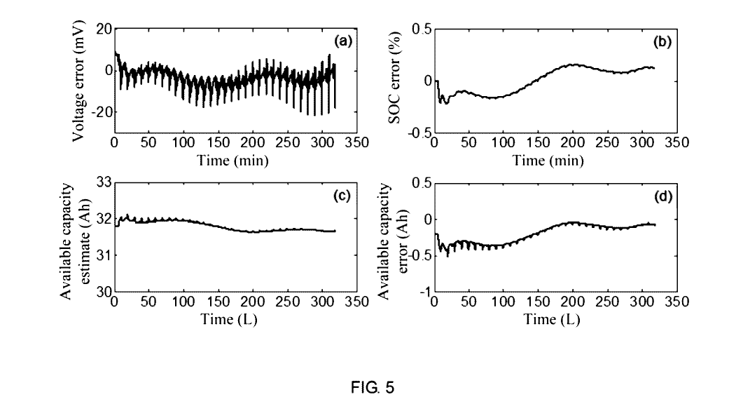

The estimation results are shown in FIG. 5 by applying the invention to estimate the battery parameter and state jointly, in which the time scale L is set to 60 s, and the sampling points is 2000. Based on the above, the following conclusions can be made.

Firstly, the convergent battery voltage estimation error, SoC estimation error and available capacity estimation error are respectively effectively limited within 25 mV, 0.5% and 0.5 Ah with the inaccurate battery available capacity and initial SoC value applied in electric vehicles. It shows that the available capacity estimate is tending towards stability gradually by using the same innovation source at the same moment to estimate the battery parameter change based on the macroscopic time scale and battery state change based on the microscopic time scale. After convergence, the available capacity estimation error is within 0.5 Ah, whose accuracy is much higher than the design requirement of the present mainstream battery management system applied in electric vehicles. This invention related to the parameter and state estimation method of a power system of an electric vehicle can be used to estimate the battery parameters and state of the battery management system applied in electric vehicles.

Secondly, the change of battery available capacity estimation result is stable, which will not shake in spite of the uncertain current or power excitation, and will converge to the test-obtained reference very quickly.

Thirdly,the calculation time cost is 2.512 s.

In conclusion, the invented estimation method possesses good correction capability against inaccurate battery available capacity and initial SoC values, and the calculation time for estimation is 2.512 s, indicating the high-speed calculation ability.

### Embodiment for Comparison

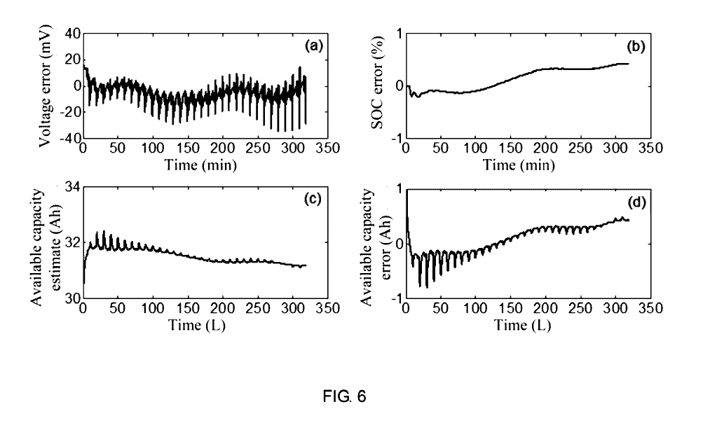

The invented estimation method is applied to estimate the battery parameter and state jointly of electric vehicles with the time scale being 1 s, and the sampling points being 21,000. During the estimation process, as the time scale L is set to 1 s, the method which bases the multi-time scale to realize the joint estimation of battery parameter and state will degrade to the single time scale joint estimation of battery parameter and state, and the estimation results are shown in FIG. 6. The following conclusions can be made.

Firstly, the battery voltage estimation error, SoC estimation error and the available capacity error are respectively less than 40 mV (millivolt), 1% and 1 Ah. That is the available capacity estimation error is less than 1Ah/31.8 Ah=3.1%. It shows that the available capacity estimate is tending towards stability gradually by using the same innovation source at the same moment to estimate the battery parameter change based on the macroscopic time scale and battery state change based on the microscopic time scale. After convergence, the available capacity estimation error is within 1 Ah, whose accuracy is higher than the design requirement of the present mainstream battery management system applied in electric vehicles.

Secondly, the maximum convergent estimation errors of battery voltage, SOC and available capacity are respectively less than 35 mV, 1% and 1 Ah. It can be observed that the high estimation accuracy is obtained when using this invention to estimate battery SoC and available capacity, which indicates that the battery parameter and state estimation accuracy can still be guaranteed even based on the initial SoC and available capacity with large error.

Thirdly, the voltage and available capacity estimation results fluctuate greatly with large battery working current. From FIG. 6(a) and FIG. 6(c), it can be seen that the obvious spike indicates the moment when the battery transfers to rest state from with big current excitation. Because the same innovation source is applied to estimate the battery parameter and state, the available capacity estimation is tending towards stability, and the available capacity error is within 1 Ah after full convergence.

Fourthly, the calculation time cost is 4.709 s.

In conclusion, the invented estimation method possesses good correction capability against inaccurate battery available capacity and initial SoC values, and the calculation time for estimation is 4.709 s, indicating the high-speed calculation ability.

By comparing FIG. 5 and FIG. 6, it can be seen that the joint estimation results of battery parameter and state based on the multi-time scale possesses higher accuracy than the joint estimation results of battery parameter and state based on the single time scale, which will result in safe, reliable, and efficient work of the battery management system. Besides, the available capacity and SoC will converge to the test-obtained reference more quickly and reliably with erroneous available capacity and initial SoC value, indicating its effective capability to solve the non-convergence problem. Also, the convergent estimation errors of battery voltage, SoC and available capacity are all within 1%, whose estimation accuracy is much higher than that of the battery SoC and available capacity estimation of the present mainstream battery management system applied in electric vehicles. Furthermore, the calculation time decreased to 2.512 s from 4.709 s, which has reduced the calculation cost of the battery management system by saving 47% calculation time.

### Embodiment 2

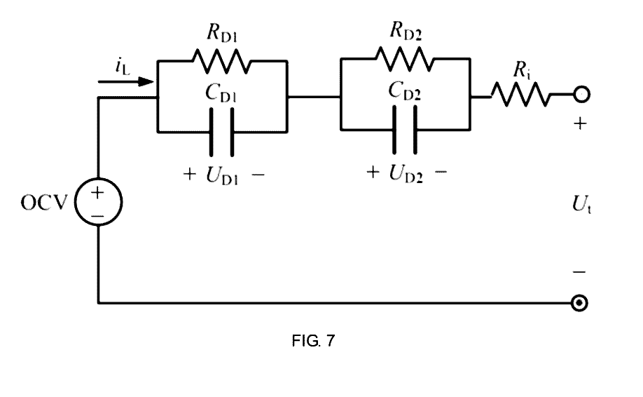

The electric battery is equalized to the equivalent circuit model with second order RC networks, which is illustrated in FIG. 7. The state function and observation function of the equivalent circuit model are shown as (41),

$$\{ \begin{matrix}\begin{matrix}{x}_{k , l + 1} = [ \begin{matrix}exp ( - \frac{{T}_{t}}{{R}_{D 1} {C}_{D 1}} ) & 0 & 0 \\ 0 & exp ( - \frac{{T}_{t}}{{R}_{D 2} {C}_{D 2}} ) & 0 \\ 0 & 0 & 1\end{matrix} ] {x}_{k , l} + \\ [ \begin{matrix}( 1 - exp ( - \frac{1}{{R}_{D 1} {C}_{D 1}} ) ) {R}_{D 1} \\ ( 1 - exp ( - \frac{{T}_{t}}{{R}_{D 2} {C}_{D 2} } ) ) {R}_{D 2} \\ - \frac{{T}_{t}}{{C}_{a}}\end{matrix} ] {u}_{k , l + 1} + {ω}_{k , l + 1}\end{matrix} , \\ {Y}_{k , l} = g ( x ( 3 ) , {C}_{a} ) - x ( 1 ) - x ( 2 ) - {R}_{l} {u}_{k , l} + {v}_{k , l}\end{matrix} \qquad ( 41 )$$

where,

R_{D1} and R_{D2} are the polarization resistances,

C_{D1} and C_{D2} are the polarization capacitances,

Rᵢ is the battery ohmic resistance,

Cₐ is the battery available capacity,

g (x(3),Cₐ) is the battery open circuit model;

the battery parameter to estimate is θ=[R_{D}C_{D}RᵢCₐ],

x is the battery state to estimate, and the state x includes x(1)−U_{D1}, x(2)−U_{D2} and x(3)−SoC, U_{D1} and U_{D2} are the battery polarization voltages.

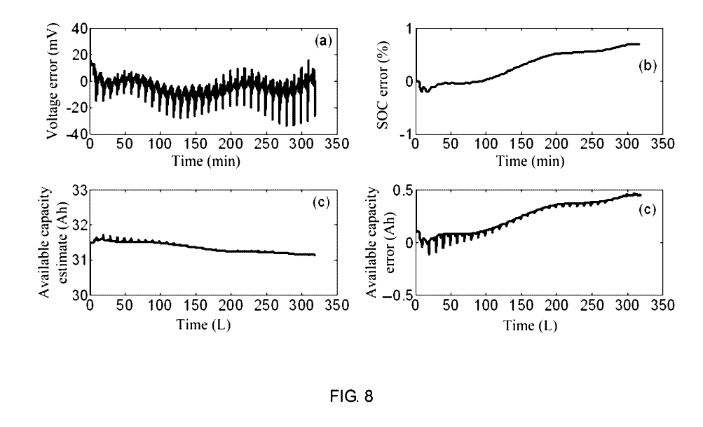

The invention is applied to estimate the battery parameter and state jointly with the time scale being 6 s, and the sampling points being 21,000. The estimation results are plotted in FIG. 8. From FIG. 8, the followings can be concluded.

Firstly, the convergent estimation errors of battery voltage, SoC and available capacity have been respectively effectively limited within 30 mV, 1% and 0.5 Ah, even with inaccurate battery available capacity and initial SoC value applied in electric vehicles. It shows that the available capacity estimate is tending towards stability gradually by using the same innovation source at the same moment to estimate the battery parameter change based on the macroscopic time scale and battery state change based on the microscopic time scale. After convergence, the available capacity estimation error is within 0.5 Ah, whose accuracy is much higher than the design requirement of the present mainstream battery management system applied in electric vehicles. Herein, this invention related to the power system parameter and state estimation method of electric vehicles can be used to estimate the battery parameter and state of the battery management system applied in electric vehicles,

Secondly, the change of battery available capacity estimation result is stable, which will not shake in spite of the uncertain current or power excitation, and will converge to the test-obtained reference very quickly.

Thirdly, the calculation time cost is 4.084 s

By comparing the estimation results of Embodiment 1 and Embodiment 2, it can be known that the two estimation accuracies are close to each other. However, adding more RC networks to the equivalent circuit model will increase the calculation time, which will then increase the calculation cost.

We claim:

1. A method for estimating the parameters and the state of a power system of an electric vehicle, comprising the following steps of:
Step 1, constructing a multi-time scale model of the power system
$$\{ \begin{matrix}{x}_{k , l + 1} = F ( {x}_{k , l} , {θ}_{k} , {u}_{k , l} ) + {ω}_{k , l} , {θ}_{k + 1} = {θ}_{k} + {ρ}_{k} \\ {Y}_{k , l} = G ( {x}_{k , l} , {θ}_{k} , {u}_{k , l} ) + {v}_{k , l}\end{matrix} ,$$
in which
θ indicates the parameters of the power system,
x indicates a hidden state of the power system,
F(x_{k,l},θₖ,u_{k,l}) indicates a state function of the multi-time scale model,
G(x_{k,l},θₖ,u_{k,l}) indicates an observation function of the multi-time scale model,
x_{k,l} is the power system state at moment t_{k,l}=t_{k,θ}+l×Δt(1≦l≦L), and k is the macroscopic time scale, l is the microscopic time scale, L is the transfer threshold between the microscopic and macroscopic time scale.
u_{k,l} is the input information of the power system at a moment t_{k,l},
Y_{k,l} is the measurement matrix of the power system at a moment t_{k,l},
ω_{k,l} is the white noise of the power system state, its mean is zero and its covariance is Q^{θ}ₖ,
ρ_{k,l} is the white noise of the power system parameter, its mean is zero and its covariance is Q^{θ}ₖ,
ν_{k,l} is the measurement white noise of the power system, its mean is zero and its covariance is R_{k,l},
and θₖ=θ_{k,θ,l-1};
Step 2, initialing θᵤ, P^{θ}₀, Q^{θ}₀ and R₀ of the parameter observer AEKF_{θ} based on the macroscopic time scale, in which
θ₀ is the parameter initial value of the parameter observer AEKF_{θ}, P^{θ}₀ is the initial covariance error matrix value of the parameter estimation of the parameter observer AEKF_{θ},
Q^{θ}₀ is the initial covariance error matrix value of the power system noise of the parameter observer AEKF_{θ},
R_{D} is the observation noise of the parameter observer AEKF_{θ}; initializing x_{θ,θ}, P^{x}_{θ,θ}, and R_{θ,θ} of the state observer AEKFₓ based on the microscopic time scale, in which,
x_{θ,θ} is the initial state value of the power system of the state observer AEKFₓ,
P^{x}_{θ,θ} is the initial covariance error matrix value of the state estimation of the state observer AEKFₓ,
Q^{x}_{θ,θ} is the initial covariance error matrix value of the power system noise of the state observer AEKF_{θ},
R_{θ,θ} the initial covariance matrix of the observation noise of the state observer AEKFₓ;
and Rₖ=R_{k,θ,l-1};
Step 3, performing time update on the parameter observer AEKF_{θ}, in which the updated time scale is a macroscopic time scale, and getting the prior estimate \hat{θ}⁻ₗ of θ at the moment t_{l,θ}, and
$$\{ \begin{matrix}{\hat{θ}}_{1}^{-} = {\hat{θ}}_{0} \\ {P}_{1}^{θ , -} = {P}_{0}^{θ} + {Q}_{0}^{θ}\end{matrix} ;$$
Step 4, performing time update and measurement update on the state observer AEKFₓ: performing time update on the state observer AEKFₓ, in which the updated time scale is a microscopic time scale, and obtaining the prior estimate \hat{x}_{θ,l} of x at the moment t_{θ,l}, wherein
$$\{ \begin{matrix}{\hat{x}}_{0 , 1}^{-} = F ( {\hat{x}}_{0 , 0}^{-} , {\hat{θ}}_{0}^{-} , {u}_{0 , 1} ) \\ {P}_{0 , 1}^{x , -} = {A}_{0 , 1} {P}_{0 , 1}^{x} {A}_{0 , 1}^{T} + {Q}_{0 , 1}^{x}\end{matrix} ,$$
A_{θ,l} is the Jacobian matrix of the state function of power system at the moment t_{θ,l} applied in electric vehicles, and
$${A}_{0 , 1} = \frac{\partial F ( x , {\hat{θ}}_{0}^{-} , {u}_{0 , 1} )}{\partial x} {\vert}^{x = {\hat{x}}_{0 , 1}} ,$$
and
T is the matrix transpose;
updating the state observer AEKFₓ based on the measurement, and obtaining the posterior estimate \hat{x}⁻_{θ,l} of x,
updating the innovation matrix for state estimation to get:
e_{θ,1}=Y_{θ,1}−G(\hat{x}⁻_{θ,1}, \hat{θ}⁻ₗ,u_{θ,l}),
wherein the Kalman gain matrix is:
K^{x}_{θ,l}=P^{x,-}_{θ,l}(C^{x}_{θ,l})^{T}(C^{x}_{θ,l}P^{x,-}_{θ,l}(C^{x}_{θ,l})^{T}+R_{θ,θ})⁻¹, and
the window length function of voltage error estimation
$${H}_{0 , 1}^{x} = \frac{1}{{M}_{x}} {\sum }_{i = 1 - M , + 1}^{l} {e}_{0 , 1} {e}_{0 , 1}^{T} ;$$
updating the covariance matrix of noise:
$$\{ \begin{matrix}{R}_{0 , 1} = {H}_{0 , 1}^{x} - {C}_{0 , 1}^{x} - {{P}_{0 , 1}^{x , -} ( {C}_{0 , 1}^{x} )}^{T} \\ {Q}_{0 , 1}^{x} = {K}_{0 , 1}^{x} {{H}_{0 , 1}^{x} ( {K}_{0 , 1}^{x} )}^{T}\end{matrix} ;$$
correcting the state estimate: \hat{x}⁻_{θ,l}=\hat{x}_{θ,l}+K^{x}_{θ,l}[Y_{θ,l}−G(\hat{x}⁻_{θ,l},\hat{θ}₁,u_{θ,1})]:
updating the estimate error covariance of state:
P^{x,-}_{θ,1}=(I−K^{x}_{θ,1}C^{x}_{θ,1})P^{x,-}_{θ,l},
where
C^{x}_{θ,l} is the Jacobian matrix of the observation function of power system at the moment t_{θ,l} applied in electric vehicles, and
$${C}_{0 , 1}^{x} = \frac{\partial G ( x , {\hat{θ}}_{1}^{-} , {u}_{0 , 1} )}{\partial x} {\vert}_{x = {\hat{x}}_{0 , 1}} ;$$
cycling the above operations for L times until the moment of state observer AEKFₓ is updated to t_{θ,l}, then going to the next step;
Step 5, updating the parameter observer AEKF_{θ} based on the measurement to get the posterior estimate \hat{θ}⁻ₗ;
updating the innovation matrix for parameter estimation to get:
e^{θ}ₗ=Y_{1,0}−G(\hat{x}⁻_{1,θ},\hat{θ}⁻ₗ,u_{1,θ}), wherein
the Kalman gain matrix is: K^{θ}₁=P^{θ,-}ₗ(C^{θ}ₗ)^{T}(C^{θ}ₗP^{θ-}ₗ(C^{θ}ₗ)^{T}+Rᵤ)⁻¹, and the window length function of voltage error estimation is:
$${H}_{1}^{θ} = \frac{1}{{M}_{θ}} {\sum }_{i = 1 - {M}_{θ} + 1}^{l} {{e}_{1}^{θ} ( {e}_{1}^{θ} )}^{T} ;$$
updating the covariance matrix of noise:
$$\{ \begin{matrix}{R}_{1} = {H}_{1}^{θ} - {C}_{1}^{θ} {{P}_{1}^{θ , -} ( {C}_{1}^{θ} )}^{T} \\ {Q}_{1}^{θ} = {K}_{1}^{θ} {{H}_{1}^{θ} ( {K}_{1}^{θ} )}^{T}\end{matrix} ;$$
correcting the state estimate: \hat{θ}⁻ₗ=\hat{θ}⁻ₗ+K^{θ}ₗe^{θ}ₗ;
updating the estimate error covariance of state: P^{θ,-}ₗ=(I−K^{θ}ₗC^{θ}ₗ)P^{θ,-}ₗ,
where
C^{θ}ₗ is the Jacobian matrix of the observation function of power system at the moment t_{1,0} applied in electric vehicles, and
$${C}_{1}^{θ} = \frac{\partial G ( {\hat{x}}_{1 , 0} , θ , {u}_{1 , 0} )}{\partial θ} {\vert}_{θ = {\hat{x}}_{1}^{-}} ;$$
cycling the operations of step 3 and step 4 until the moment t_{k,l},
performing time update on the parameter observer AEKF_{θ} to get the prior estimate \hat{θ}⁻ₖ of parameter θ at the moment t_{k,l}, wherein
$$\{ \begin{matrix}{\hat{θ}}_{k}^{-} = {\hat{θ}}_{k - 1} \\ {P}_{k}^{θ , -} = {P}_{k - 1}^{θ} + {Q}_{k - 1}^{θ}\end{matrix} ;$$
performing time update on the state observer AEKFₓ to get the prior estimate \hat{x}⁻_{k-1,l} of state \hat{x}⁻_{k-1,l} at the moment t_{k,l}, wherein
$$\{ \begin{matrix}{\hat{x}}_{k - 1 , l}^{-} = F ( {\hat{x}}_{k - 1 , l - 1}^{-} , {\hat{θ}}_{k}^{-} , {u}_{k - 1 , l - 1} ) \\ {P}_{k - 1 , l}^{x , -} = {A}_{k - 1 , l - 1} {P}_{k - 1 , l - 1}^{x} {A}_{k - 1 , l - 1}^{T} + {Q}_{k - 1 , l - 1}^{x}\end{matrix} ,$$
A_{k-1,l-1} is the Jacobian matrix of the state function of power system at the moment t_{k,l} applied in electric vehicles, and
$${A}_{k - 1 , l - 1} = \frac{\partial F ( x , {\hat{θ}}_{k}^{-} , {u}_{k - 1 , l} )}{\partial x} {\vert}_{x = {\hat{x}}_{k - 1 , l - 1}} ;$$
updating the state observer AEKFₓ based on the measurement to obtain the posterior estimate \hat{x}⁻_{k-1,l} of state x at the moment t_{k,l},
updating the innovation matrix for state estimation to get: e_{k-1,l}=Y_{k-1,l}G(\hat{x}⁻_{k-1,l},\hat{θ}⁻ₖ,u_{k-1,l}), wherein the Kalman gain matrix is
K^{x}_{k-1,l}=P^{x-}_{k-1,l}(C^{x}_{k-1,l})^{T}(C^{x}_{k-1,l}P^{x,-}_{k-1,l}(C^{x}_{k-1,l})^{T}+R_{k-1,l-1})⁻¹;
matching the covariance adaptively:
$${H}_{k - 1 , l}^{x} = \frac{1}{{M}_{x}} {\sum }_{i = l - {M}_{x} + 1}^{l} {e}_{k - 1 ,} {e}_{k - 1 , l}^{T} ;$$
updating the noise covariance:
$$\{ \begin{matrix}{R}_{k - 1 , l} = {H}_{k - 1 , l}^{x} - {C}_{k - 1 , l}^{x} {{P}_{k - 1 , l}^{x , -} ( {C}_{k - 1 , l}^{x} )}^{T} \\ {Q}_{k - 1 , l}^{x} = {K}_{k - 1 , l}^{x} {{H}_{k - 1 , l}^{x} ( {K}_{k - 1 , l}^{x} )}^{T}\end{matrix} ;$$
correcting the state estimate:
\hat{x}⁻_{k-1,l}=\hat{x}⁻_{k-1,l}+K^{x}_{k-1,l}[Y_{k-1,l}−G(\hat{x}⁻_{k-1,l},\hat{θ}⁻ₖ,u_{k-1,l})];
updating the error covariance of state estimate;
P^{x,-}_{k-1,l}=(I−K^{x}_{k-1,l}C^{x}_{k-1,l})P^{x,-}_{k-1,l},
where
C^{x}_{k-1,l} is the Jacobian matrix of the observation function of power system at the moment t_{k,l} applied in electric vehicles, and
$${C}_{k - 1 , l}^{x} = \frac{\partial G ( x , {\hat{θ}}_{k}^{-} , {u}_{k - 1 , l} )}{\partial x} \vert x = {\hat{x}}_{k - 1 , l} ;$$
updating the parameter observer AEKF_{θ} based on the measurement to obtain the posterior estimate \hat{θ}⁻ₖ of parameter θ at the moment t_{k,θ,l};
updating the innovation matrix for parameter estimation to get: e^{θ}ₖ=Y_{k,θ}−G(\hat{x}⁻_{k,θ},\hat{θ}ₖ,u_{k,θ}), wherein
the Kalman gain matrix is:
K^{x}_{k-1,l}=P^{x,-}_{k-1,l}(C^{x}_{k-1,l})^{T}(C^{x}_{k-1,l}P^{x,-}_{k-1,l}(C^{x}_{k-1,l})^{T}+R_{k-1,l-1})⁻¹;
matching the covariance adaptively:
$${H}_{k}^{θ} = \frac{1}{{M}_{θ}} {\sum }_{i = 1 - {M}_{θ} + 1}^{l} {{e}_{k}^{θ} ( {e}_{k}^{θ} )}^{T} ;$$
updating the noise covariance:
$$\{ \begin{matrix}{R}_{k} = {H}_{k}^{θ} - {C}_{k}^{θ} {{P}_{k}^{θ , -} ( {C}_{k}^{θ} )}^{T} \\ {Q}_{k}^{θ} = {K}_{k}^{θ} {{H}_{k}^{θ} ( {K}_{k}^{θ} )}^{T}\end{matrix} ;$$
correcting the state estimate: \hat{θ}⁺ₖ=\hat{θ}⁻ₖ+K⁰ₖe⁰ₖ;
updating the error covariance of state estimate: P^{0,+}ₖ=(I−K⁰ₖC⁰ₖ)P^{θ,-}ₖ
where
C⁰ₖ is the Jacobian matrix of the observation function of power system at the moment t_{k,0-L} applied in electric vehicles, and
$${C}_{k}^{θ} = \frac{\partial G ( {\hat{x}}_{k , 0} θ , {u}_{k , θ} )}{\partial θ} {\vert}_{θ = {\hat{x}}_{1}^{-}} ;$$
and cycling the above operations until the estimation is completed.

2. The method according to claim 1, wherein when performing time update on the state observer AEKFₓ, the cycle of the microscopic time scale is l=1:L; when l=L, the macroscopic time scale transfers to k from k-1, and the microscopic time scale transfers to L from 0.

3. The method according to claim 1, wherein the cycle data of the power system of the electric vehicle is input in a state estimation filter in real time.

4. The method according to claim 2, wherein the cycle data of the power system of the electric vehicle is input in a state estimation filter in real time.

5. A power battery management system applying the method according to claim 1.

6. A power battery management system applying the method according to claim 2.

7. A power battery management system applying the method according to claim 3.

8. A power battery management system applying the method according to claim 4.
